(19) United States
(12) Patent Application Publication
(10) Pub. No.: US 2017/0206800 A1
(43) Pub. Date: Jul. 20, 2017

(54) Electronic Reading Device

(71) Applicant: Paul Siani, Greater London (GB)

(72) Inventor: Paul Siani, Greater London (GB)

(21) Appl. No.: 15/419,739

(22) Filed: Jan. 30, 2017

Related U.S. Application Data
(63) Continuation of application No. 14/247,487, filed on Apr. 8, 2014, now abandoned.
Application No. 14/247,487 is a continuation of application No. 13/322,822, filed on Nov. 28, 2011, now abandoned.

(30) Foreign Application Priority Data
May 29, 2009 (GB) 0909317.0

(51) Int. Cl. G09B 17/00; G09B 5/06

(52) U.S. Cl. CPC G09B 17/006; G09B 5/06

(57) ABSTRACT

An electronic device is provided which can be used, for example, by a user who is learning to read, to input a word in question and be provided with visual and audio output of the phonetic components of the query word, thereby assisting the learning of pronunciation of the word. The electronic device includes a plurality of word databases corresponding to different predefined classification, such as reading level, age group or reading syllabus.

This invention relates to an electronic reading apparatus, and more particularly to an electronic reading apparatus with visual and audio output for assisted learning.

A common problem when one is learning to read, whether as a child in school or an adult learning a new language, is that a proper pronunciation of the words is not apparent without assistance from a native speaker. US 2006/0031072 discusses an electronic dictionary apparatus which includes a database containing entry words and advanced phonetic information corresponding to each entry word. A dictionary search section searches the database using an entry word specified by a user as a search key and acquires the advanced phonetic information corresponding to the entry word. A display section displays the simple phonetic information generated based on the acquired advanced phonetic information. A speech output section performs speech synthesis based on the acquired advanced phonetic information and outputs the synthesized speech.

The present invention aims to provide an electronic device for assisted learning which has improved functionality.

According to one aspect of the present invention, an electronic device is provided which can be used, for example, by a user who is learning to read, to input a word in question and be provided with visual and audio output assisting the learning of the pronunciation of the target word by syllables or phonetic components. The electronic device comprises a memory storing a plurality of word databases, wherein each word database contains a list of words associated with a predefined classification, and a visual representation and an audible representation of components of each word, means for selecting one of said plurality of word databases, means for receiving a user input character sequence, means for retrieving the visual representation and audible representation of components of at least one word from the selected word database, and means for outputting the retrieved visual representation and audible representation of components of at least one word.

According to another aspect of the present invention, a method of assisted learning is provided, using an electronic device including a memory storing a plurality of word databases, wherein each word database contains a list of words associated with a predefined classification, and a visual representation and an audible representation of components of each word, the method comprising selecting one of said plurality of word databases, receiving a user input character sequence, retrieving the visual representation and audible representation of components of at least one word from the selected word database, and outputting the retrieved visual representation and audible representation of components of at least one word.

In yet a further aspect of the invention, there is provided a computer readable medium storing instructions which when cause a programmable device to become con figured as the above electronic device.

### BRIEF DESCRIPTION OF THE DRAWINGS

Specific embodiments of the present invention will now be described with reference to the accompanying drawings, in which:

FIG. 1 is a block diagram of an electronic device according to an embodiment of the invention;

FIG. 2 is a block diagram of the functional components of the electronic device of FIG. 1 according to an embodiment of the invention;

FIG. 3 is a flow diagram of the operation of providing a visual and audible representation of a user input word according to an embodiment of the invention;

FIG. 4, which comprises FIGS. 4a and 4b, is a schematic illustration of user interface of the electronic device to demonstrate examples of the device in use according to an embodiment of the invention; and

FIG. 5 is a schematic illustration of an example visual output displayed by the electronic device in response to input by a user according to an embodiment of the invention.

### DETAILED DESCRIPTION OF EMBODIMENTS OF THE INVENTION

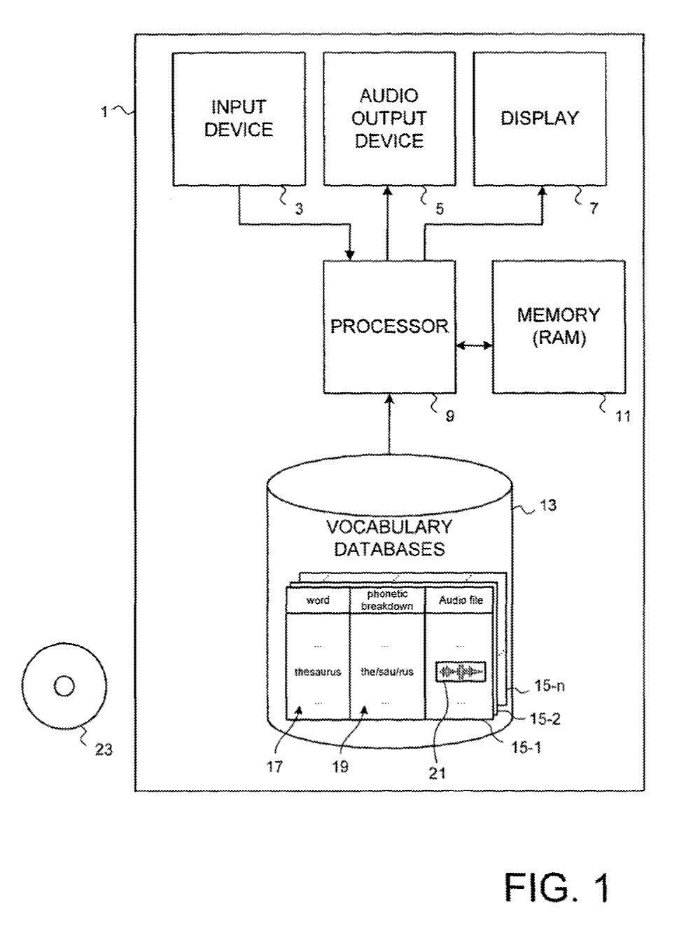

FIG. 1 is a block diagram schematically illustrating the hardware components of an electronic device 1 according to one embodiment of the invention. In this embodiment, the electronic device includes a user input device 3 such as a keyboard for user input, a audio output device 5 such as a loudspeaker for audio output and a display 7 for visual output. A processor 9 is provided for overall control of the electronic device 1 and may have associated with it a memory 11, such as RAM.

The electronic device 1 also includes a data store 13 for storing a plurality of vocabulary databases 15-1 . . . 15-n, each vocabulary database 15 associated with a predefined classification such as a particular reading level, age group or reading syllabus. Each vocabulary database 15 has a data structure that contains a plurality of words 17 associated with the classification of that vocabulary database 15, as well as a corresponding phonetic breakdown 19 and an audible representation 21 of each word in the vocabulary database 15. In this embodiment, each audible representation is provided as a pre-recorded audio file 21. As those skilled in the art will appreciate, the data structure may also contain other information which may be accessible by a user as an additional, optional, mode.

The list of words 17 for a particular vocabulary database 15 may consist of new words that are introduced to reading material targeting each predefined classification. For example, a first vocabulary database 15-1 may consist of a list of words 17 extracted from reading material such as books targeting the youngest reading age group, which may be ages up to three years old. A second vocabulary database 15-2 may consist of a distinct list of words 17 extracted from reading material targeting the next reading age group, which may be ages from three to seven years old. The second vocabulary database 15-2 may exclude all of the words present in the first vocabulary database 15-1. Further distinct vocabulary databases 15-n may be similarly compiled for the remaining reading age groups. As another example, the predefined classification may instead be a standard set list of reading material for respective reading levels or syllabuses. One example is the Oxford Reading Tree which provides set lists of books for each progressive reading stage from 1 to 16 and for reading age groups of 4-5 years, 5-6 years, 6-7 years, 7-8 years, 8-9 years, 9-10 years and 10-11 years. The list of words 17 for each of the plurality of vocabulary databases 15 may be similarly compiled from the reading material for each reading level or syllabus. In this way, different vocabulary databases 15 are provided targeting for example each progressive reading level, age group or syllabus, with the list of words in a vocabulary database 15 for a higher reading level, older age group or reading syllabus containing longer and more complex words than the list of words in a vocabulary database 15 for a lower reading level, younger age group or reading syllabus.

In this embodiment, each distinct vocabulary database 15 is loaded into the data store 13 of the electronic device 1 from one or more external storage media 23, such as a CD, DVD or removable flash memory. For example, a plurality of CDs 23 may be provided, each CD storing a vocabulary database 15 of a predefined classification. As another example, one or more DVDs may be provided, storing a plurality of vocabulary databases 15 for a range of classifications. As those skilled in the art will appreciate, the electronic device may alternatively be arranged to access a vocabulary database 15 directly from an external storage media 23.

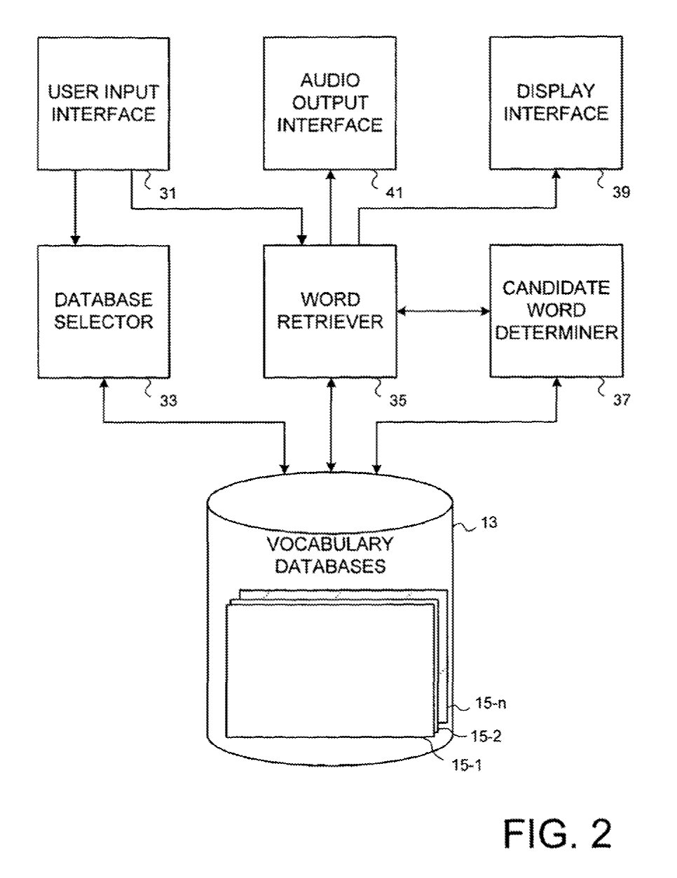

The overall operation of the electronic device 1 will now be described with reference to FIG. 2 which is a block diagram showing the functional components of the electronic device 1 shown in FIG. 1. As shown in FIG. 2, a user input interface 31 receives input from the input device 3, for example an indication of a particular classification, such as a reading level, age group or reading syllabus. A database selector 33 receives the user input indication of the classification and selects a corresponding vocabulary database 15 from the data store 13. The user input interface 31 also receives input representing characters of a user input word. A word retriever 35 receives the user input word and determines if the user input word is present in the vocabulary database 15 selected by the database selector 33. If the user input word is not present, for example if the user has mistyped or misspelled the word, a candidate word determiner 37 determines one or more candidate words in the selected vocabulary database 15. As those skilled in the art will appreciate, this determination may be made in any number of ways. For example, the candidate word determiner 37 may identify a candidate word in the selected vocabulary database 15 as the word which shares the greatest number of characters as the user input word. Adjacent words may also be selected as additional candidate words when the words of the selected vocabulary database 15 are considered in alphabetical order. As another example, the candidate word determiner 37 may calculate a match score for each word in the selected vocabulary database 15 using on a predetermined matching algorithm and select the one or more words with the best score. In this way, three candidate words are identified by the candidate word determiner 37, for example by identifying one word before and one word after the closest matching candidate word, or the two words after the closest matching candidate word. The user is then prompted to select one of the identified candidate words for retrieval. On the other hand, the candidate word determiner 37 is not used if the user input word is present. The word retriever 35 retrieves the corresponding phonetic breakdown 19 for the user input word as well as the audio file 21. The phonetic breakdown 19 is displayed on the display 7 via display interface 39 and the audible representation in audio file 21 is output by audio output device 5 via audio output interface 41.

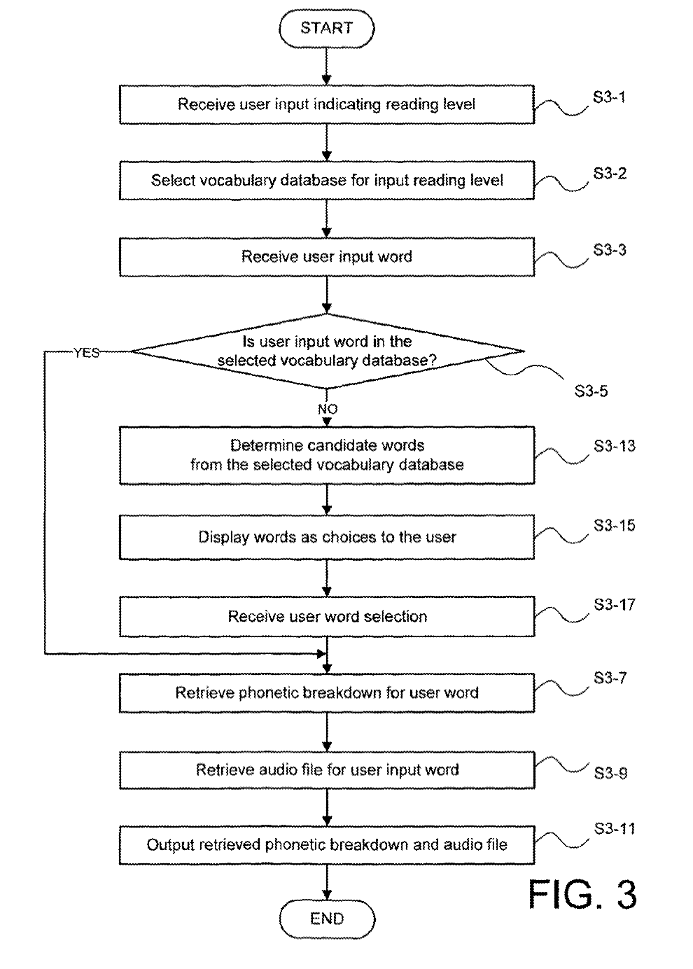

The operation of the electronic device 1 according to the present embodiment will now be described in more detail with reference to the flow diagram shown in FIG. 3. As shown in FIG. 3, at step S3-1, the user input interface 31 receives user input for determining a reading level of the user, in response for example to a prompt displayed on the display 7. For example, the user input may be the user's age or an alpha-numerical reading level. The user input may be entered via the input device 3 which may be a keyboard, or alternatively may be via menu option selection buttons corresponding to a displayed menu of available vocabulary databases 15, either stored in the data store 13 or on a removable storage media 23. At step S3-2, the database selector 33 receives the user input reading level and selects a corresponding vocabulary database 15 from the data store 13. For example, the input reading level may be the user's age and the database selector 33 may then retrieve a vocabulary database for age range including the user input age. As another example, the user input may be an indication of the reading age range of an available vocabulary database 15 and the database selector 33 can simply select the user-specified vocabulary database 15.

Having selected a vocabulary database 15 corresponding to a user indicated classification, which in this embodiment is a reading level, at step S3-3 the user is prompted to input a query word and the user input word is received by the user input interface 31 and passed to the word retriever 35. At step S3-5, the word retriever 35 determines if the user input word is present in the selected vocabulary database 15. If it is determined at step S3-5 that the word is present, then at step S3-7, the word retriever 35 retrieves the phonetic breakdown for the user input word from the selected vocabulary database 15 and at step S3-9, retrieves the audio file for the user input word from the selected vocabulary database 15. At step S3-11, the word retriever 35 passes the retrieved phonetic breakdown to the display interface 39 for output on the display 7 and passes the retrieved audio file to the audio output interface 41 for processing as necessary and subsequent output on audio output device 5.

If, on the other hand, it is determined at step S3-5 that the word is not present in the selected vocabulary database 15, then at step S3-13, the candidate word determiner 37 determines three candidate words in the selected vocabulary database 15 that match the user input word. As discussed above, the candidate word determiner 37 may identify a first candidate word in the selected vocabulary database 15 as the word which matches the greatest number of characters in the user input word, and then select the next two words in the selected vocabulary database 15 when the words of the selected vocabulary database 15 are considered in alphabetical order as the two additional candidate words. Various specific implementations are envisaged for determining the candidate words, and the present invention is not limited by any one particular technique. The advantage arises because a particular vocabulary database 15 is selected based on the user input classification and therefore the candidate words that are displayed as choices to the user at step S5-15 are more likely to be pertinent to the user because the word choices derive from the selected vocabulary database 15.

At step S3-17, the user input interface 31 receives a user selection of one of the candidate words displayed at step S3-15. The processing then passes to steps S5-7 to S5-11 as described above, where the user selected word is passed to the word retriever 35 for retrieval and output of the visual and audible representations of the query word as discussed above.

In this way, the user is provided with an electronic reading assistant which will provide a proper pronunciation for each phonetic component or syllable of an input query word, together with a display highlighting the phonetic component or syllable as the audio representation is being output by the electronic device. Additionally, the electronic device advantageously provides the user with one or more word choices in the event that the input word is not recognised, for example because it has been mistyped or misspelled. Moreover, the displayed word options are more likely to be pertinent to the user's query because the selected vocabulary database only contains words for the user's indicated classification, e.g. the particular reading level, age group or reading syllabus.

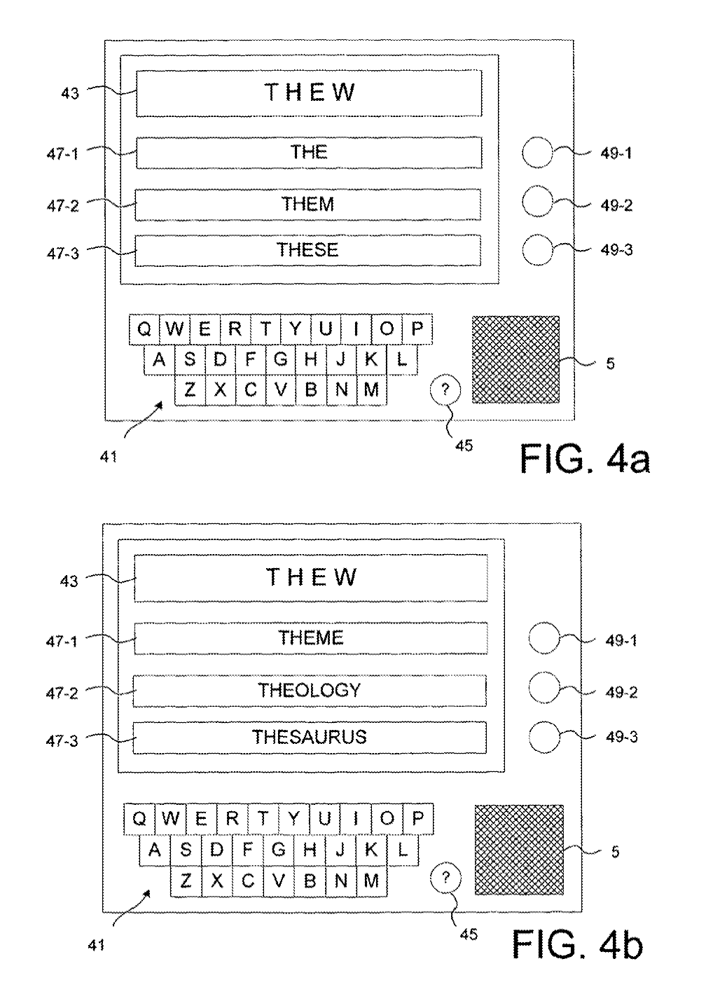

For example, if the user indicates a reading age of three years, the database selector 33 may select the vocabulary database for the reading age group for four to five year olds. This particular vocabulary database can be expected to contain simple and basic words which are commonly used in books targeted for that reading age group. An example of the electronic device 1 in use according to this example is shown in FIG. 4a, which is a schematic illustration of the user interface of the electronic device according to the present embodiment. As shown in FIG. 4a, the user has misspelled a word by entering the characters “T H E W” using the keyboard 41. The input characters are displayed in a display window 43 of the display 7 as they are being input by the user. In this embodiment, the user inputs all of the characters of the query word and then presses a button 45 to indicate that the query word has been entered. As discussed above, the word retriever 35 determines that the query word “THEW” is not present in the selected vocabulary database 15 for the reading age group for four to five year olds. The candidate word determiner 37 therefore identifies the three candidate words as “THE” (matching all three initial characters of the input word), “THEM” and “THESE” (which in this illustrated example would be the next two words in the selected vocabulary database 15 in alphabetical ordering). The three identified candidate words are displayed as word options 47-1, 47-2 and 47-3 in the display 7, with corresponding selection buttons 49-1, 49-2 and 49-3 provided adjacent each word option.

FIG. 4b shows an example of the same input query word but a different selected vocabulary database 15. In this example, the user may have input a reading level age of eleven and the database selector 33 may consequently select a vocabulary database 15 for an older reading age group, such as nine to ten year olds. As mentioned above, this particular vocabulary database can be expected to contain relatively more complicated words compared to the vocabulary database for the young reading age group, including many more multiple syllable words compared to the vocabulary database for four to five year olds. Moreover, this vocabulary database may include a wholly different set of words to that of the vocabulary database for four to five year olds. As a result, the candidate word determiner 37 in this example will identify three different words which are then displayed to the user, the words in the illustrated example being “THEME”, “THEOLOGY” and “THESAURUS”. In this way, the present invention advantageously provides improved utility because the user is presented with a displayed choice of a subset of correctly spelled words, where each displayed word choice has a greater chance of being the word that the user was attempting to enter. This is because the identified words are derived from the selected vocabulary database 15 for that reading level and therefore words that the user is unlikely to encounter or to have difficulties pronouncing would not be present in that selected vocabulary database 15.

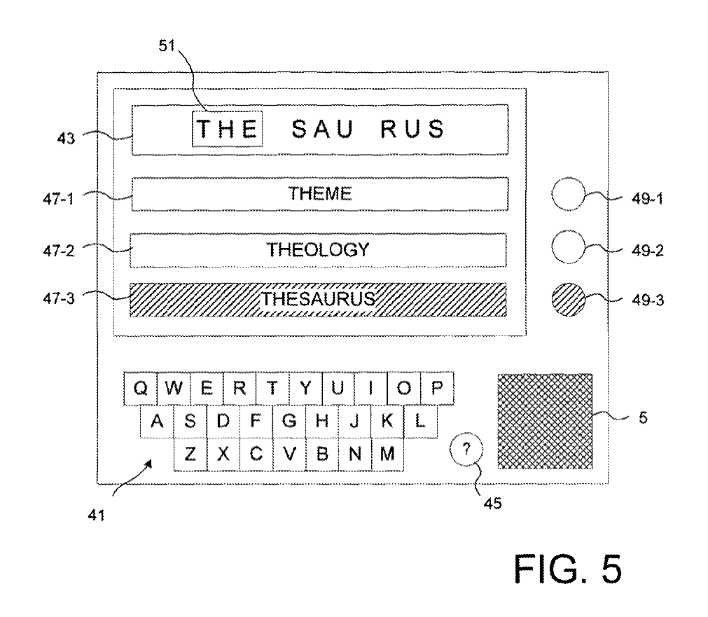

FIG. 5 is a schematic illustration of the user interface of the electronic device according to the present embodiment after the user has selected the word choice “THESAURUS” by pressing the corresponding selection button 49-1, 49-2 or 49-3. In this embodiment, the retrieved phonetic breakdown 19 is displayed in the window 43 of the display, and each phonetic component or syllable is highlighted 51 in turn, as the respective portion of the retrieved audio file 21 is output through a loudspeaker 5. As those skilled in the art will appreciate, the audio file 21 may include markers between each phonetic component to enable the respective displayed phonetic component to be highlighted 51 in the window 43 of the display 7.

### Alternatives and Modifications

It will be understood that embodiments of the present invention are described herein by way of example only, and that various changes and modifications may be made without departing from the scope of the invention.

For example, in the embodiment described above, the electronic device includes a keyboard for user input. As those skilled in the art will appreciate, alternative forms of user input may instead or additionally be included. For example, the electronic device may include a touch screen or a mobile telephone style alpha-numeric keypad. As yet another example, the electronic device may include a microphone for receiving spoken user input of each character of an input word. As those skilled in the art will appreciate, in this alternative, the electronic device will also by provided with basic speech recognition functionary to process the spoken input characters.

In the embodiment described above, the candidate word determiner is used to identify one or more words which match a user input word only when the user input word is not present in the selected vocabulary database. As an alternative, the electronic device may be arranged to always display a plurality of candidate words from the selected vocabulary database, even in the case where the user input word is present. In such a case, the electronic device may be arranged to display the user input word and for example two adjacent words as described above, and the user may select, listen to and learn the pronunciation of all three candidate words.

In the embodiment described above, the electronic device is arranged to receive a user input word before proceeding to determine if that input word is present in the selected vocabulary database. As those skilled in the art will appreciate, as an alternative, the steps of determining if a user input word is in the selected vocabulary database, determining candidate words that match the user input word and displaying the identified words as choices to the user may be performed each time a new character is input by the user. In this way, the plurality of word options provided to the user may change as each subsequent character is input by the user, and the user may not need to enter all the characters of the query word. As discussed above, the displayed options are more likely to be pertinent to the user's query because the selected vocabulary database only contains words for the user's indicated classification, e.g. the particular reading level, age group or reading syllabus. Furthermore, as mentioned above, the user may also advantageously select, listen to and learn the pronunciation of other words in addition to the word in question.

In the embodiment described above, the user interface provides three word options to the user, with three corresponding selection buttons. As those skilled in the art will appreciate, any number of options may be provided to the user, each with a corresponding selection button. Additionally, a scroll up button and/or a scroll down button may be provided for the user to indicate that none of the displayed word options are desired. In response, the candidate word determiner may be used to identify a different plurality of candidate words for subsequent display to the user. As yet a further modification, an error message may be displayed to the user to clearly indicate that the input word is not present in the selected vocabulary database.

In the embodiment described above, the vocabulary databases contain audio representations of each word in the form of an audio file. As those skilled in the art will appreciate, as an alternative, the electronic device may contain speech synthesis functionality to generate the audio representation from the word itself. However, this alternative is less desirable because a pre-recorded recording of a proper pronunciation will be more accurate.

In the embodiment described above, the predefined classification is one of a reading level, age group or reading syllabus. As those skilled in the art will appreciate, the classification may instead or in addition include different languages or regional dialects or accents. In this way, the plurality of vocabulary databases may be further tailored to assisted learning by a specific reader. As yet a further alternative, pre-recorded audio representations for each vocabulary database may include a different voice depending on the reading level, age group or reading syllabus. For example, a recording by a younger speaker may be used for a corresponding classification so that the pronunciation and intonation may advantageously be more appropriate for that classification.

In the embodiment described above, the data store includes a plurality of vocabulary databases, where the term “database” is used in general terms to mean the data structure as described above with reference to FIG. 1. As those skilled in the art will appreciate, the actual structure of the data store will depend on the file system and/or database system that is used. For example, a basic database system may store the plurality of vocabulary databases as a flat table, with an index indicating the associated classification. As another example, each vocabulary database may be provided as a separate table in a data store. As yet another example, each vocabulary database may be provided on distinct removable media, such as CDs, essentially resulting in a set of vocabulary databases where the appropriate vocabulary database for a particular user can be selected and then inserted into the electronic device, and the initial steps of receiving a user indication of reading level or other classification will not be necessary.

In the above description, the electronic device is provided with a processor and memory (RAM) arranged to store and execute software which controls the respective operation to perform the method described with reference to FIG. 3. As those skilled in the art will appreciate, a computer program for configuring a programmable device to become operable to perform the above method may be stored on a carrier or computer readable medium and loaded into the memory for subsequent execution by the processor. The scope of the present invention includes the program and the carrier or computer readable medium carrying the program.

In an alternative embodiment, the invention can be implemented as control logic in hardware, firmware, or software or any combination thereof. For example, the functional components described above and illustrated in FIG. 2 may be provided in dedicated hardware circuitry which receives and processes user input signals from the user input device 3.

1. An electronic device comprising:
memory storing a plurality of word databases, wherein each word database contains:
a list of words associated with a first language and one of a reading level, age group or reading syllabus, each of said plurality of word databases containing a list of words that differ in complexity from each of the other plurality of word databases; and
a visual representation and an audible representation of components of each word;
a determiner operable to determine a classification of a user based on an input received from the user;
a first retriever operable to select one of said plurality of word databases based upon the classification of the user and the complexity of words contained in the selected one of said plurality of word databases, and to retrieve from the memory selected one of said plurality of word databases;
a receiver operable to receive a user input character sequence;
a match determiner operable to determine a subset of candidate words from the selected word database based on the user input character sequence received by the receiver;
a second retriever operable to receive an indication of the subset of candidate words from the match determiner, and to retrieve the visual representation and audible representation of components of said candidate words from the selected word database;
a display operable to output the retrieved visual representation of components a selected candidate word; and
an audio output device operable to output the retrieved audible representation of components the selected candidate word retrieved by the second retriever.

2. The electronic device of claim 1, wherein the components are phonetic components of a word.

3. The electronic device of claim 1, wherein the audible representation of components of each word is provided as an audio file including a recording of a pronunciation of each component of components of each word.

4. The electronic device of claim 1, further comprising a speech synthesis module operable to generate a synthesized speech sound for each component of the word from said stored audible representation of the word.

5. The electronic device of claim 1, wherein the user input character sequence is a portion of the word retrieved from a stored word database.

6. The device of claim 1, wherein the match determiner is operable to determine a subset of candidate words that share the greatest number of characters with the user input character sequence, wherein at least one candidate word does not match all of the characters of the user input character sequence.

7. The electronic device of claim 1, wherein the memory comprises at least one removable computer readable medium.

8. The electronic device of claim 7, wherein the memory comprises one or more of a CD, DVD and flash memory.

9. (canceled)

10. The electronic device of claim 6, wherein the list of words for each of said plurality of word databases are non-overlapping.

11. The electronic device of claim 1, further comprising a selection output operable to output the determined plurality of candidate words as selections to the user.

12. A method of assisted learning using an electronic device including a memory storing a plurality of word databases, wherein each word database contains a list of words associated with a first language and one of a reading level, age group or reading syllabus; and a visual representation and an audible representation of components of each word, and wherein the list of words in a word database associated with the first language and a higher reading level, older age group or reading syllabus contains words of a different complexity than the list of words in a word database associated with a lower reading level, younger age group or reading syllabus, the method comprising:
receiving a user input from a user;
determining a classification of the user based on the user input;
selecting one of said plurality of word databases based upon the classification of the user and the complexity of words contained in the selected one of said plurality of word databases;
retrieving from the memory the selected one of said plurality of word databases;
receiving a user input character sequence;
determining a subset of candidate words from the selected word database based on the received user input character sequence;
retrieving the visual representation and audible representation of components of said candidate words from the selected word database; and
outputting the retrieved visual representation and audible representation of components of said candidate words.

13. The method of claim 12, wherein the components are phonetic components of a word.

14. The method of claim 12, wherein the audible representation of components of each word is provided as an audio file including a recording of a pronunciation of each component of components of each word.

15. The method of claim 12, further comprising generating a synthesized speech sound for each component of the word from said stored audible representation of the word.

16. The method of claim 12, wherein the user input character sequence is a portion of the word retrieved from a stored word database.

17. The method of claim 12, wherein the subset of candidate words comprises words from the selected word database that share the greatest number of characters with the user input character sequence, wherein at least one candidate word docs not match all of the characters of the user input character sequence.

18. A non-transitory computer-readable storage medium storing computer executable instructions that when executed perform the method of assisted learning using an electronic device including a memory storing a plurality of word databases, wherein each word database contains a list of words associated with a first language and one of a reading level, age group or reading syllabus; and a visual representation and an audible representation of components of each word, and wherein the list of words in a word database associated with the first language and a higher reading level, older age group or reading syllabus contains words of a different complexity than the list of words in a word database associated with the first language a lower reading level, younger age group or reading syllabus, comprising:
receiving a user input from a user;
determining a classification of the user based on the user input;
selecting one of said plurality of word databases based upon the classification of the user and the complexity of words contained in the selected one of said plurality of word databases;
retrieving from the memory the selected one of said plurality of word databases;
receiving a user input character sequence;
determining a subset of candidate words from the selected word database based on the received user input character sequence;
retrieving the visual representation and audible representation of components of said candidate words from the selected word database; and
outputting the retrieved visual representation and audible representation of components of said candidate words.

19. The method of claim 1, wherein the list of words in a word database associated with the first language and a higher reading level or older age group contains words of a different complexity than the list of words in a word database associated with the first language and a lower reading level or younger age group, and wherein the selected one of said plurality of word databases contains words matching a reading level or age group of the classification of the user.

20. The method of claim 1, wherein the classification comprises a regional dialect or accent associated with the first language and wherein the selected one of said plurality of word databases is selected further based on the regional dialect or accent.
